(19) United States
(12) Patent Application Publication
(10) Pub. No.: US 2026/0156056 A1
(43) Pub. Date: Jun. 4, 2026

(54) METHODS, ARCHITECTURES, APPARATUSES AND SYSTEMS FOR RADIO RESOURCE CONTROL STATE OPTIMIZATION FOR FEDERATED LEARNING

(71) Applicant: InterDigital Patent Holdings, Inc., Wilmington, DE (US)

(72) Inventors: Oumer Teyeb, Montreal (CA); Morteza Kheirkhah, London (GB); Tejaswinee Lutchoomun, Montreal (CA); Yugeswar Deenoo Narayanan Thangaraj, Chalfont, PA (US)

(21) Appl. No.: 19/126,472

(22) PCT Filed: Nov. 1, 2023
(86) PCT No.: PCT/US2023/036561

§ 371 Date: May 1, 2025

Related U.S. Application Data
(60) Provisional application No. 63/421,615, filed on Nov. 2, 2022.

(51) Int. Cl. H04L 43/065; H04L 41/16

(52) U.S. Cl. CPC H04L 43/065; H04L 41/16

(57) ABSTRACT

Procedures, methods, architectures, apparatuses, systems, devices, and computer program products are provided for federated learning. In certain embodiments, a wireless transmit/receive unit (WTRU) may receive information which configures resource availability reporting as it pertains to WTRU resources which are available for a service and/or federated learning. The WTRU may receive information which configures timing information as to when the WTRU may send a resource availability report. In some embodiments, a WTRU may send a resource availability report immediately upon being configured for resource availability reporting. In some embodiments, a resource availability report (e.g., resource availability indication) may be sent while the WTRU is a low power state. In some embodiments, the WTRU may transition to a connected state before sending a resource availability report.

### CROSS-REFERENCE TO RELATED APPLICATIONS

This application claims the benefit of U.S. Provisional Ser. No. 63/421,615 filed 2 Nov. 2022, which is incorporated herein by reference.

### TECHNICAL FIELD

The present disclosure is generally directed to the fields of communications, software and encoding, including, for example, to methods, architectures, apparatuses, systems directed to radio resource control (RRC) state transitions and directed to control and/or user plane uplink and/or downlink transmissions.

### BACKGROUND

In an example of federated learning (FL), a central artificial intelligence (AI) server trains a global model by combining local models trained by each participant, such as wireless transmit receive units (WTRUs) based on a model averaging technique. In the context of FL training in wireless communications, a need exists to coordinate FL training among WTRUs by taking into consideration radio resource control (RRC) states of the WTRUs.

### SUMMARY

In certain representative embodiments, procedures may be implemented by a WTRU and/or other network entities for configuring the WTRU to report (e.g., periodically report) resource availability (e.g., associated with a service and/or one or more artificial intelligence (AI) and/or machine learning (ML) models and/or functions), such as resources available (e.g., at the WTRU) for federated learning operations.

In certain representative embodiments, procedures may be implemented by a WTRU for reporting resource availability according to one or more triggers, conditions, and/or relationships.

In certain representative embodiments, procedures may be implemented by a wireless transmit/receive unit (WTRU) for reporting resource availability on a one-shot and/or immediate basis.

In certain representative embodiments, procedures may be implemented by a WTRU for reporting resource availability while in certain states, such as RRC_INACTIVE and/or RRC_IDLE.

In certain representative embodiments, procedures may be implemented by a WTRU for reporting resource availability when or after transitioning to certain states, such as RRC_CONNECTED.

In certain representative embodiments, procedures may be implemented by a WTRU for reporting resource availability using one or more small data transmissions (SDTs).

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a system diagram illustrating an example of federated learning interactions between various participants and a central server;

FIG. 3 is a system diagram illustrating an example of federated learning interactions between various participants and a FL training server;

FIG. 4 is a timing diagram illustrating an example of a 4-step random access (RA) procedure;

FIG. 5 is a timing diagram illustrating an example of a 2-step RA procedure;

FIG. 6 is a timing diagram illustrating an example of a RRC connection establishment/setup procedure;

FIG. 7 is a timing diagram illustrating an example of a RRC connection resume procedure;

FIG. 8 is a state diagram illustrating examples of transitions between different RRC states;

FIG. 9 is a syntax diagram illustrating examples of establishment and resume causes;

FIG. 10 is a timing diagram illustrating an example of a 4-step RA procedure with small data transmission (SDT);

FIG. 11 is a timing diagram illustrating an example of a 2-step RA procedure with SDT;

FIG. 12 is a timing diagram illustrating an example of a configured grant (CG) procedure with SDT;

FIG. 13 is a procedural diagram illustrating an example procedure for reporting of federated learning resource availability;

FIG. 14 is a procedural diagram illustrating an example procedure for reporting of federated learning resource availability using paging information; and

FIG. 15 is a procedural diagram illustrating another example procedure for reporting of federated learning resource availability.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

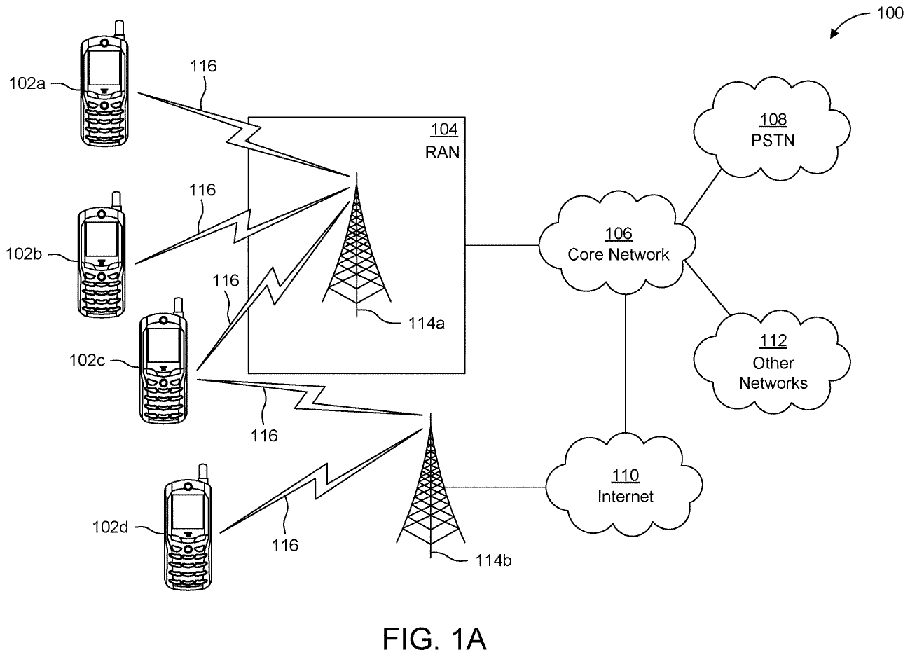

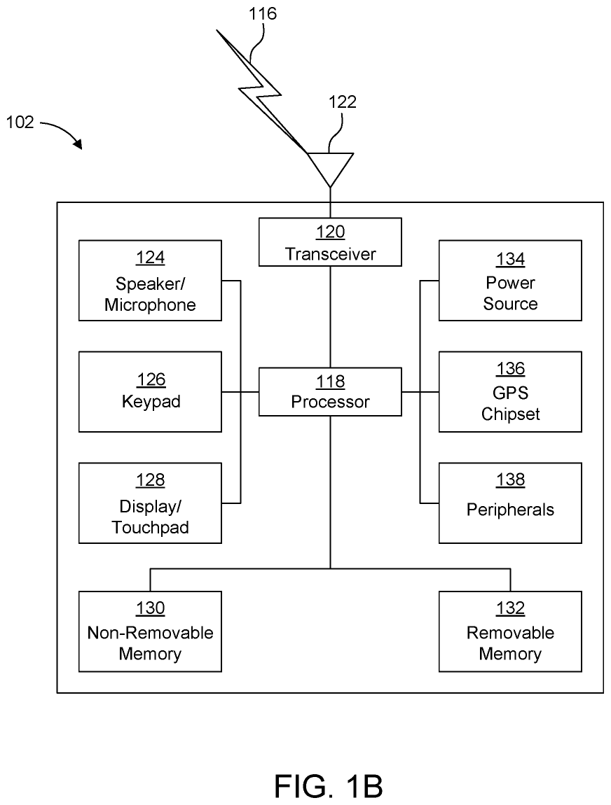

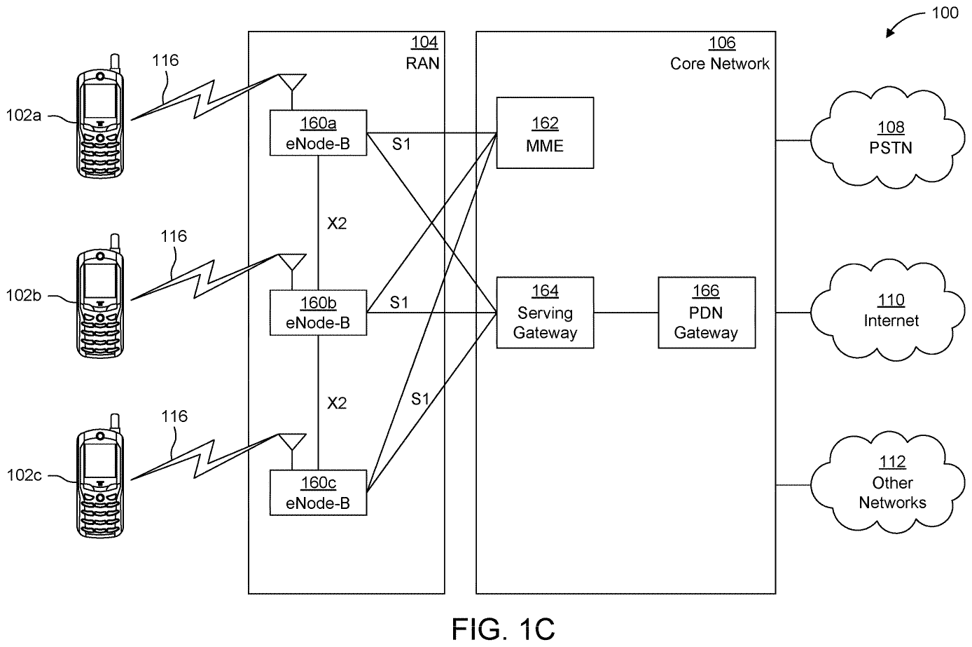

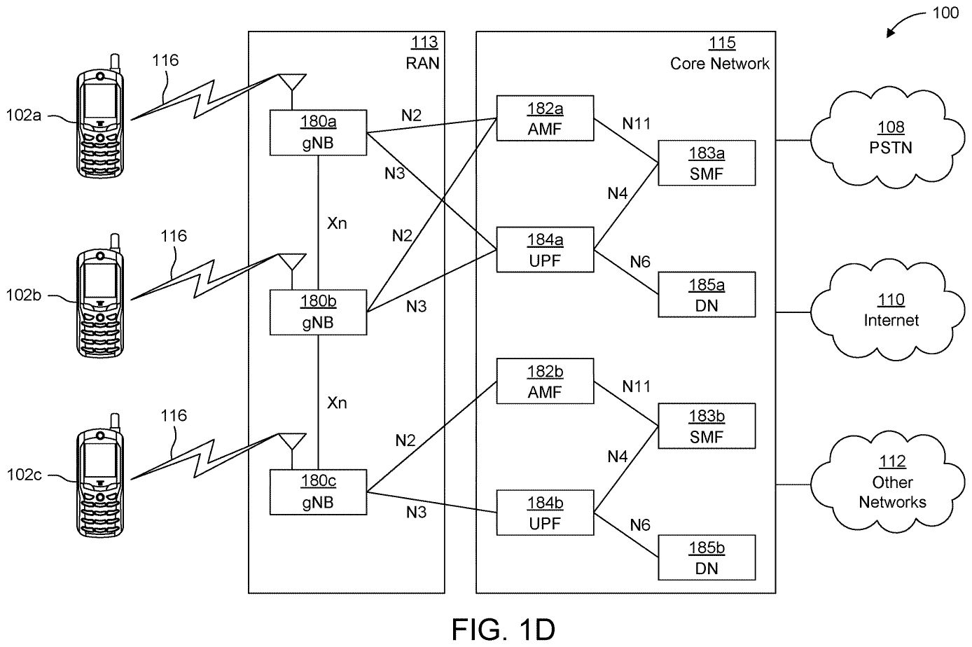

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114 a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114 b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180 c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

The following abbreviations and acronyms may be used herein:
5GC 5G Core
AI Artificial Intelligence
AC Application Client
AMF Access and Mobility Management Function
AS Application Server
AF Application Function
AN Access Network
CN Core Network
CP Control Plane
ML Machine Learning
NAS Non-Access Stratum
NF Network Function
PCF Policy Control Function
PDCP Pocket Data Convergence Protocol
RAN Radio Access Network
RLC Radio Link Control
RRC Radio Resource Control
SMF Session Management Function
SDAP Service Data Adaptation Protocol
UE User Equipment
UP User plane
UPF User Plane Function

### Overview

### AI/ML Services in 5G Systems

In certain representative embodiments, one or more WTRUs may interact with network functions (NFs) in a 5G core network. For example, a WTRU 102 may interact with any of an AI/ML function (AIMLF), federated learning function (FLF), application server (AS), and/or application function (AF) through a user plane (e.g., via UPF) and/or a control plane (e.g., via NAS signaling). In the case of UP interactions, a WTRU 102 may need to interact with at least an AS and/or AF over a data radio bearer (DRB), which is established between the WTRU 102 and NG-RAN over the Uu air interface.

### AI/ML Metadata and Operations

In certain representative embodiments, metadata may include any of model topology, model weights, training completion time window, and/or other AI/ML specific parameters. For example, AI/ML parameters may include, but are not limited to, any of loss function, entropy, prediction accuracy, and the like. In certain representative embodiments, AI/ML operations may be categorized as: (i) model distribution; (ii) model splitting between AI/ML endpoints; and (iii) federated learning.

### Federated Learning

In certain representative embodiments, a (e.g., central) AI server or function may operate in a federated learning (FL) mode. The central AI server may train a global (or central) model, such as by combining a set of local models trained by various participants (e.g., WTRUs), such as based on model averaging. A WTRU may perform local model training (e.g., within each training cycle) based on a model downloaded from the (e.g., centralized) AI server using local data (e.g., obtained by the WTRU). The training may use a set of resources at the WTRU 102. For example, the training may require a set of resources to be available (e.g., over a certain time period) at the WTRU 102. For example, the set of resources may include any of a battery power (e.g., level) of the WTRU 102, an amount of memory of the WTRU 102, and/or a processor capacity at the WTRU 102. Once the local model training is completed, the WTRU 102 may deliver training results (e.g., a gradient for the Deep Neural Network-DNN) to the centralized AI server, such as via UL channels. Next, the (e.g., centralized) AI server may aggregate the gradients (e.g., model weights) from the WTRUs, and update the global (or central) model. For example, a next training cycle may begin where the AI server distributes the updated global model to one or more WTRUs, such as via DL channels.

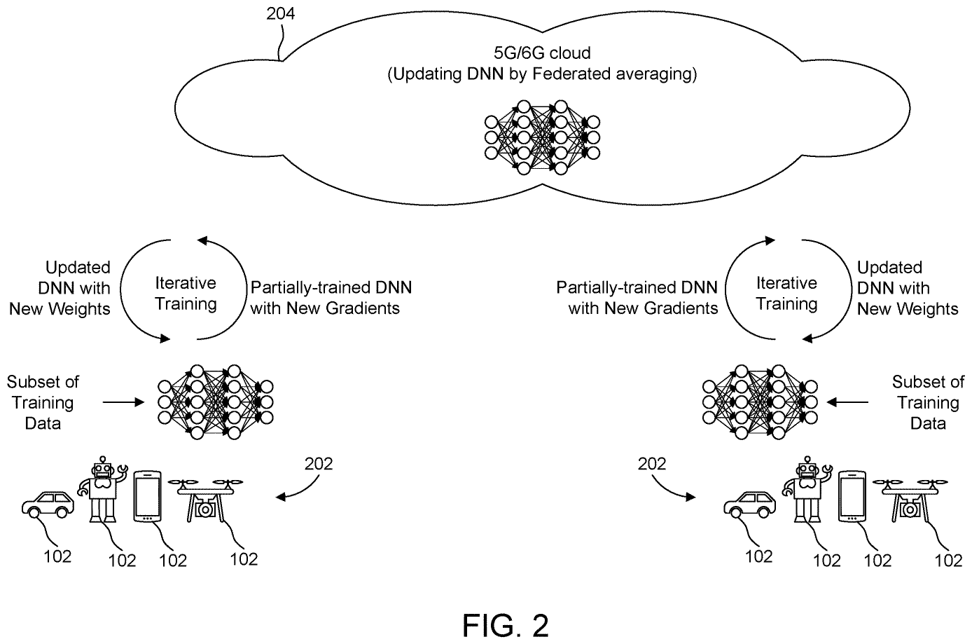

FIG. 2 is a system diagram illustrating an example of a federated learning system with various participants 202 and a central server 204, such as a 5G or 6G cloud.

In certain representative embodiments, FL training over wireless communication, where participants (e.g., WTRUs 102) may have highly variable conditions in terms of available computational (e.g., memory and/or processing capacity) and network resources, may be (e.g., slightly) different than FL training in data centers. In certain representative embodiments, WTRUs 102 may not be homogeneous, so the WTRUs 102 may have different capabilities in terms of respective computing and network-related resources and/or even what AI and/or ML frameworks (e.g., functions and/or models) they support. For example, it may not be efficient for a centralized AI server to include all participants 202 (e.g., WTRUs 102) in a training session, so some sort of member selection mechanism may be needed before each training cycle begins. For example, consideration may be given where conditions (e.g., device computation resource and/or wireless channel conditions) are not changed, WTRU (re-)selection and training re-configurations might not be needed for each training cycle. In some examples, it may be beneficial (e.g., crucial) to (re)select different WTRUs 102 over time to achieve global training with diverse datasets. For example, computing resources may include any of battery power (e.g., a percentage of total battery power), memory (e.g., in Mbytes), and/or processing (e.g., a percentage of total CPU and/or GPU) capacity.

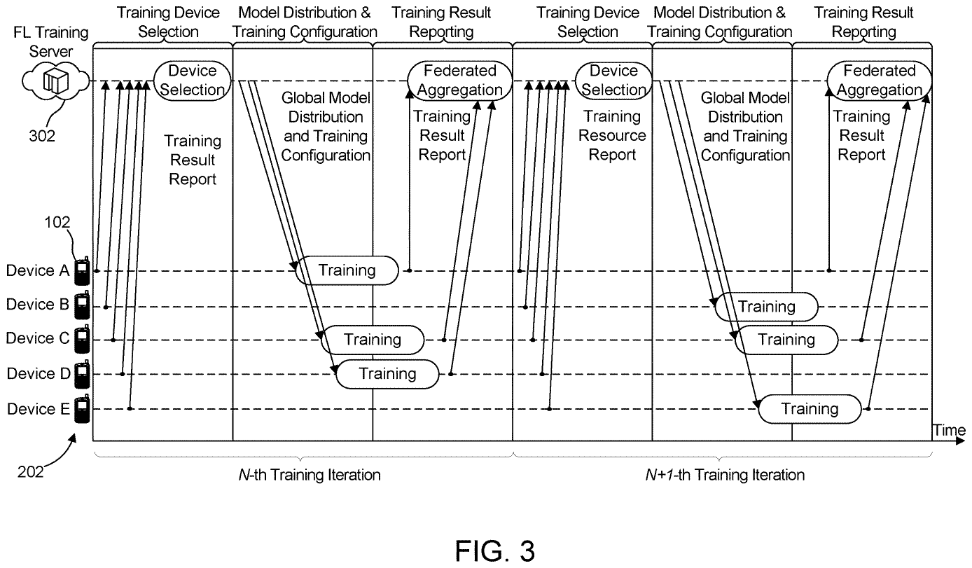

FIG. 3 is a system diagram illustrating an example of federated learning interactions between various participants 202 (e.g., devices A-E, such as WTRUs 102) and a FL training server 302.

In FIG. 3, a FL scenario may include a set of participants 202 (e.g., devices A-E) which are involved in a distributed training session. For example, all devices (e.g., WTRUs 102) may not be involved in all training cycles. In some training cycles, some WTRUs 102 may be inactive, while in other sessions, the WTRUs 102 may be configured to perform training of a local model. For example, a device A may initially (e.g., during the N-th cycle) be engaged in a training session, but after the device A reports its training resources, the centralized FL server 302 may not (re)select device A for a next cycle (e.g., the N+1-th cycle). For example, the FL server 302 may instead select a device B (e.g., which is inactive during the N-th cycle). In some representative embodiments, there may be periods and/or cycles that a WTRU 102 or the FL server 302 may be inactive between and/or during the training sessions.

In certain representative embodiments, a (e.g., each) FL training cycle may be categorized into three operating stages. In the first operating stage, the FL training server 302 may select a set of devices (e.g., WTRUs 102) for training. During this stage, the training devices (e.g., WTRUs 102) may first inform their training resources to the FL training server 302. Once the FL server 302 collects resource information from the training devices, the FL training server 302 may select some WTRUs 102 (e.g., a set of WTRUs 102). The FL server 302 may then move to the next operating stage of model distribution and training configuration. Here, the FL server 302 may distribute a global trained model and related configurations to all selected devices (e.g., WTRUs 102). Upon reception of the global trained model and related configurations, the selected devices may start local model training, such as at one or more different points in time. Once the local training is completed at a device, the locally trained model and/or associated training information may be delivered to the FL server 302. After receiving the locally trained model and/or associated training information, the third operating stage may be begin. During this stage, the FL server 302 may aggregate any (e.g., all) training results to form a (e.g., updated) global model. Thereafter, the whole training workflow may be repeated one or more times.

### 2-Step and 4-Step Random Access Procedures

For example, random access can be performed in a contention-based fashion (e.g., contention based random access (CBRA)) or contention free fashion (e.g., contention free random access (CFRA)). The two types of random access which are supported in NR are 4-step RA, and 2-step RA. For example, a 4-step RACH procedure may be performed along with the RRC resume/setup procedure. For example, a 2-step RACH procedure may be useful in scenarios where latency is important, as the signaling exchange necessary to complete the random-access procedure is reduced.

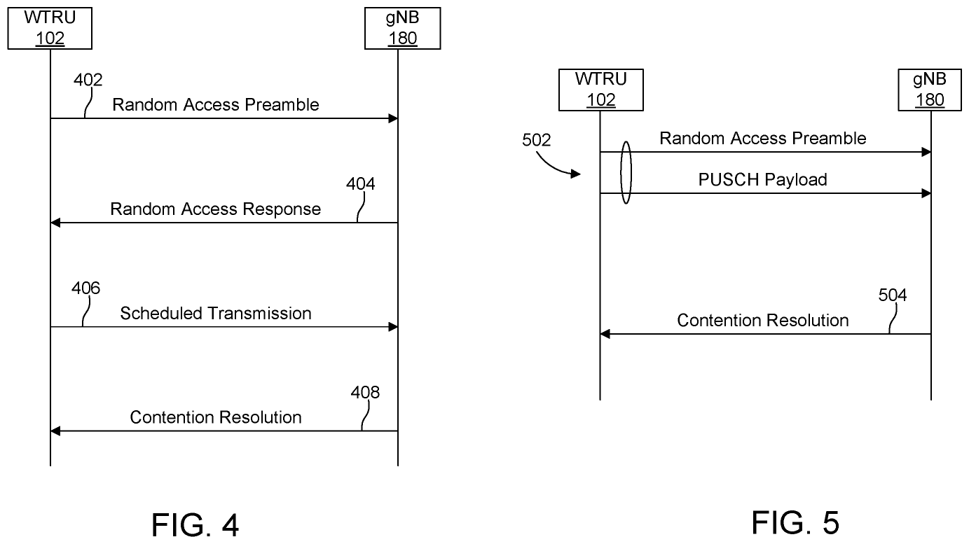

FIG. 4 is a timing diagram illustrating an example of a 4-step random access procedure. In FIG. 4, the procedure may begin at 402 with a WTRU 102 transmitting a Msg 1, which contains a preamble on PRACH, to a gNB 180. After MSG1 transmission, the WTRU 102 may monitor at 404 for a random access response (e.g., RAR/Msg 2) from the network within a configured window. After reception of the RAR, which contains a UL grant and a timing advance command, the WTRU 102 may apply the timing advance command and send a Msg 3 at 406 using the UL grant provided in the RAR. After Msg3 transmission, the WTRU 102 may monitor for a network response (e.g., Msg 4) containing contention resolution information at 408.

For example, where contention resolution is successful, random access is complete and the WTRU 102 begins a connection with the gNB 180. Where contention resolution fails, the WTRU 102 may restart the random access procedure via (e.g., another) transmission of a Msg1.

FIG. 5 is a timing diagram illustrating an example of a 2-step random access procedure. In FIG. 5, the 2-step random access may begin with transmission of a MsgA, which includes a preamble on PRACH and a payload on PUSCH, at 502 to a gNB. After MsgA transmission, the WTRU 102 may monitor for a response (e.g., MsgB) from the gNB within a configured window containing information regarding contention resolution at 504.

For example, where contention resolution is successful, the WTRU 102 may terminate the random access procedure. Where contention resolution fails and a fallback indication is provided in the MsgB, the WTRU 102 may perform a Msg3 transmission using an UL grant contained within the MsgB fallback indication, and begins to monitor for contention resolution. Where contention resolution fails again after the Msg3 transmission, the WTRU 102 may revert back to MsgA transmission. If the MsgA transmission fails a configured number of times, the WTRU 102 may revert back to the 4-step Random access.

Which type of random access procedure is used may be selected upon initiation of the random access procedure, such as based on a network configuration. When contention free random-access resources are configured, the WTRU 102 may perform 4-step or 2-step random access depending on whether the random access resources correspond to 2-step or 4-step. If contention free random-access resources are not provided, the WTRU 102 may select between 4-step and 2-step random access, such as based on an RSRP threshold.

### RRC States and State Transitions

In NR, a WTRU 102 can be in one of the following three RRC states:
(i) RRC_CONNECTED (also referred to as CONNECTED mode/state herein);
(ii) RRC_INACTIVE (also referred to as INACTIVE mode/state herein); and
(iii) RRC_IDLE (also referred to as IDLE mode/state herein).

In RRC_CONNECTED, the WTRU 102 is actively connected to the network, with signaling and data radio bearers established (e.g., SRB and DRBs), and able to receive Downlink (DL) data from the network in a unicast fashion and also send Uplink (UL) data to the network. The mobility of the WTRU 102 from one cell and/or node to another may be controlled by the network. The network may configure the WTRU 102 to send measurement reports periodically or when certain conditions are fulfilled (e.g., a neighbor cell becomes better than a serving cell by more than a certain threshold) and based on these reports may send the WTRU 102 a handover command to move the WTRU 102 to another cell and/or node. The network may also configure a conditional handover, CHO, where (e.g., instead of sending of a measurement report) the WTRU 102 may execute a preconfigured handover command when certain conditions are fulfilled. The network may also send the WTRU 102 a HO command without receiving any measurement report (e.g., based on implementation, such as the determination of the current location).

For example, keeping the WTRU 102 in connected mode may be power intensive for the WTRU 102 (e.g., the WTRU 102 needs to continuously monitor the PDCCH of the serving cell, such as for determining the arrival of DL data, for UL data scheduling, etc.,), and a certain cell and/or gNB may (e.g., only) able to accommodate a certain number of WTRUs in connected mode (e.g., due to resource limitations). When there is no activity in the UL and/or DL for a certain duration (e.g., based on an inactivity timer kept at the network), the network may send the WTRU 102 to the RRC_INACTIVE or RRC_IDLE state.

For example, where the network expects the WTRU 102 to be active for a long duration, the network may send the WTRU 102 to the RRC_IDLE state. While in RRC_IDLE, the WTRU 102 may camp at a cell (e.g., the cell with the best signal level at the highest priority RAT and highest priority frequency within that RAT), that will facilitate the WTRU 102 establishing a connection via that cell if a need arises for the WTRU 102 to transition back to the connected state. More details of the cell re-selection procedure that ensures the WTRU 102 is always camping at the best cell are described later. The WTRU 102 may also monitor the downlink paging channel to detect for DL data arrival. The WTRU 102 may initiate the connection setup/establishment procedure, such as where the WTRU 102 detects paging information from the network indicating an arrival of DL data or if the WTRU 102 needs to send UL data. The figure below illustrates the RRC connection establishment/setup and connection resume procedures.

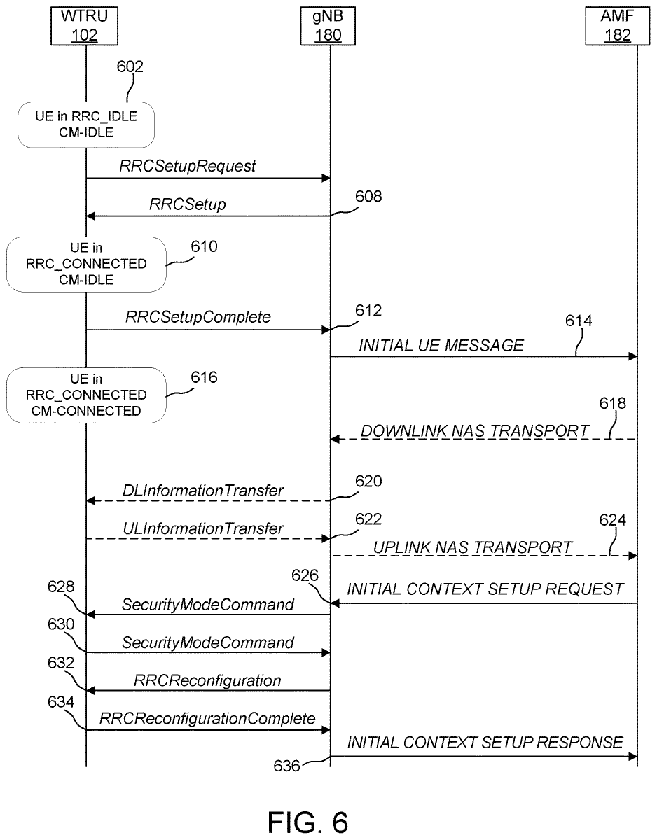

FIG. 6 is a timing diagram illustrating an example of a RRC connection establishment/setup procedure. At 602, the WTRU 102 may be in RRC_IDLE and CM-IDLE. At 604, the WTRU may send a RRCSetupRequest message to the gNB 180. At 608, the WTRU 102 may receive a RRCSetup message from the gNB 180. At 610, the WTRU 102 may be in RRC_CONNECTED and CM-IDLE. At 612, the WTRU 102 may send a RRCSetupComplete message to the gNB 180. At 614, the gNB 180 may send an initial UE message to the AMF 182. At 616, the WTRU may be in RRC_CONNECTED ad CM-CONNECTED. At 618, the AMF 182 may send a DL NAS transport message to the gNB 180. At 620, the WTRU 102 may receive DL information from the gNB 180. At 622, the WTRU 102 may send UL information to the gNB 180. At 624, the AMF 182 may receive an UL NAS transport message. At 626, the AMF may send an initial context setup request message to the gNB 180. At 628, the WTRU 102 may receive a security mode command from the gNB 180. The WTRU 102 may reply with a security mode command to the gNB 180 at 630. At 632, the WTRU 102 may receive a RRCReconfiguration message from the gNB 180. At 634, the WTRU 102 may send a RRCReconfigurationComplete message to the gNB 180. At 636, the AMF 182 may receive an initial context setup response from the gNB 180.

As can be seen in FIG. 6, the RRC connection setup procedure is a lengthy procedure that requires several round trip times (RTTs) to complete and it involves the Core Network (CN) 115. This is because when the WTRU 102 goes to IDLE mode, the WTRU's RRC context is released, and the WTRU 102 is not known at the RAN level, and the RAN 113 must fetch the WTRU 102 context from the CN 115. Also, security must be re-established after that, and the WTRU 102 reconfigured with the DRBs and SRBs before UL/DL data transmission/reception may occur.

Such a lengthy setup procedure may not be compatible with low latency services and thus 5G NR has introduced an intermediate state between the CONNECTED and IDLE states, known as the INACTIVE state. INACTIVE state has most of the power saving advantages of the IDLE state (e.g., WTRU 102 does not need to continuously monitor the PDCCH, which is one of the most power consuming procedures in the CONNECTED state), but at the same time, the RAN keeps the WTRU's RRC/Security context. When there is a need to transition the WTRU 102 to CONNECTED mode (e.g., due to the arrival of UL data or the reception of a paging indicating the arrival of DL data), the connection can be resumed very quickly, without involving the CN 115, re-establishing the WTRU's security context, and reconfiguring the bearers.

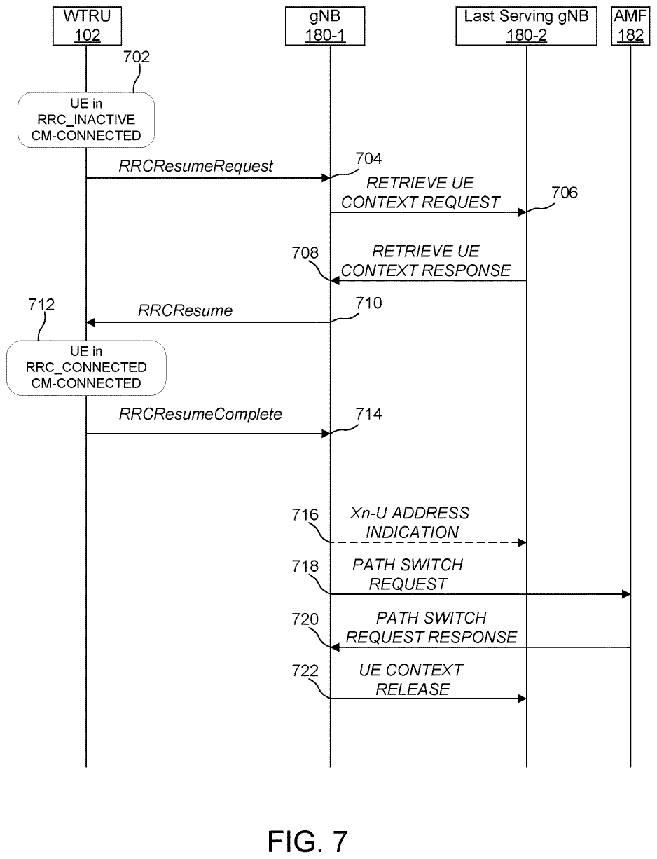

FIG. 7 is a timing diagram illustrating an example of a RRC connection resume procedure. At 702, the WTRU is in RRC_INACTIVE and CM-CONNECTED. At 704, the WTRU 102 may send a RRCResumeRequest message to a gNB 180-1. At 706, the gNB 180-1 may send a UE context request to a last serving gNB 180-2. At 708, the gNB 180-2 may send a UE context response to the gNB 180-1. At 710, the gNB 180-1 may send a RRCResume message to the WTRU 102. At 712, the WTRU is in RRC_CONNECTED and CM-CONNECTED. At 714, the WTRU may send a RRCResumeComplete message to the gNB 180-1. At 716, the gNB 180-1 may send a Xn-U address indication to the gNB 180-2. At 718, the gNB 180-1 may send a path switch request to the AMF 182. At 720, the AMF 182 may send a path switch request response to the gNB 180-1. At 722, the gNB 180-1 may send a UE context release to the gNB 180-2.

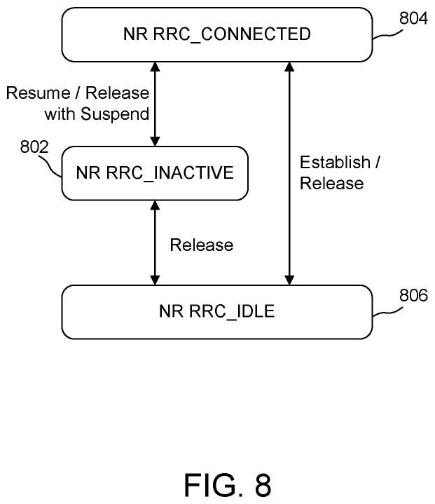

FIG. 8 is a state diagram illustrating examples of transitions between different 5G NR RRC states. In FIG. 8, a resume request may be used to transition a WTRU 102 from RRC_INACTIVE 802 to RRC_CONNECTED 804. A release request with suspend may be used to transition from RRC_CONNECTED 804 to RRC_INACTIVE 802. A release request may be used to transition from RRC_INACTIVE 802 (or RRC_CONNECTED 804) to RRC_IDLE 806. An establish request with suspend may be used to transition from RRC_IDLE 806 to RRC_CONNECTED 804. When the WTRU 102 performs the connection setup/establishment or resume procedures, the WTRU 102 may include (e.g., in the RRCSetupRequest or RRCResumeRequest), establishment or resume cause information.

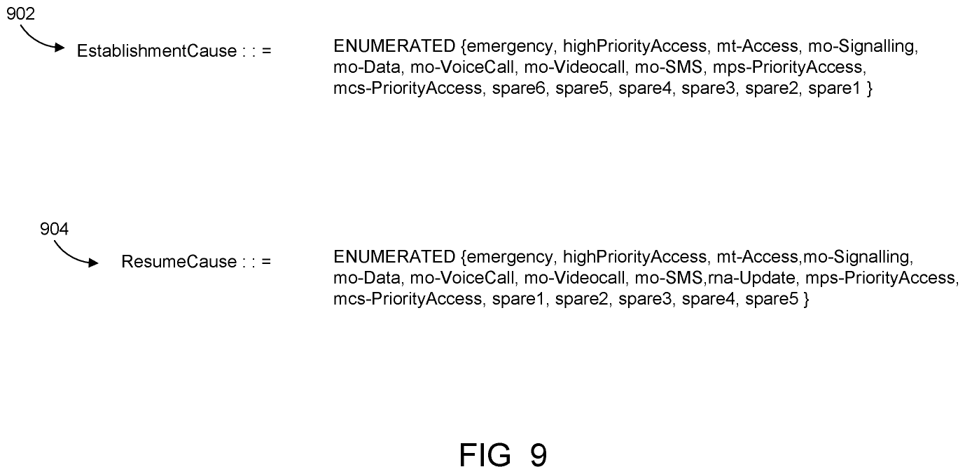

FIG. 9 is a syntax diagram illustrating examples of establishment and resume causes. For example, establishment cause information 902 may be indicated as various values which may be associated with (e.g., predetermined) causes, such as shown in FIG. 9. For example, resume cause information 904 may be indicated as various values with may be associated with (e.g., predetermined) causes, such as shown in FIG. 9.

In certain representative embodiments, a connection may be setup and/or resumed due to a voice call and/or a video call originating from a WTRU 102. For example, the WTRU 102 may set an establishment or resume cause to indicate “mo-VoiceCall” (e.g., mobile originated voice call) or “mo-VideoCall” (e.g., mobile originated video call). As another example, a connection may be setup and/or resumed due to receiving downlink paging indicating DL data (e.g., for the WTRU 102). The WTRU 102 may set the establishment or resume cause to indicate one of “mt-Access” (mobile terminated access), “highPriority Access”, “mps-Priority Access”, or “mcs-Priority Access”. The particular cause may depend on the access category of the WTRU 102.

In certain representative embodiments, a WTRU 102 may be sent to INACTIVE state, and the network may include in the RRCRelease message a suspendConfig information element. For example, a suspendConfig may include information indicating any of: a resumeIdentity, a RAN paging area, and/or a nextHopChaining count.

For example, a resumeIdentity may be used by the WTRU 102 in RRC_INACTIVE (e.g., a short identity/short I-RNTI, and/or a long identity/full I-RNTI). The WTRU 102 may determine which identity to use based on system information broadcast in the target cell (e.g., if useFullResumeID is indicated in a SIB, use the long identity, otherwise, use the short identity).

For example, a RAN paging area may indicate or otherwise be associated with a list of cells. The list of cells may be a RAN area where the WTRU 102 can be paged at the RAN level. A WTRU 102 may perform cell re-selection to a cell outside the RAN area, and the WTRU 102 may perform a RAN area update procedure. The WTRU 102 may send a resume request with a cause value indicating a RAN area update, and the network may respond with a release message. The release message may configure the WTRU 102 with a new RAN area. This procedure may be referred to as a 2-step resume procedure.

For example, a nextHopChaining count may be used for deriving a security context (e.g., encryption/integrity protection keys) upon resuming the connection.

In certain embodiments, there may be a one-to-one mapping between RRC and CM (e.g., with one exception). For example, the RRC state may be in the CONNECTED mode and the CM state may also be in the CONNECTED mode. For example, when the RRC state is in the IDLE mode then the CM state may be in the IDLE mode. As an example of an exception to the one-to-one mapping, the WTRU 102 may be in the CM_CONNECTED mode, and the RRC state may be in the INACTIVE mode.

SDT in 5G Systems

In 5G NR Release 15, a WTRU 102 in RRC Inactive may (e.g., always have to) resume the RRC connection for any of UL/DL data transmission/reception. Resuming the connection even for some small infrequent small payload data (e.g., for periodic and/or event triggered information reporting) is highly inefficient from a WTRU power consumption point of view.

In 5G NR Release 17, small data transmission (SDT) may enable a WTRU 102 in RRC Inactive state to perform data transmission, such as without requiring an RRC state transition. For example, various SDT procedures have been standardized in Release 17. Discussions on how to enhance SDT for DL transmission have occurred with respect to Release 18.

### Random Access Channel (RACH) SDT

In certain representative embodiments, a 4-step RA procedure may include SDT.

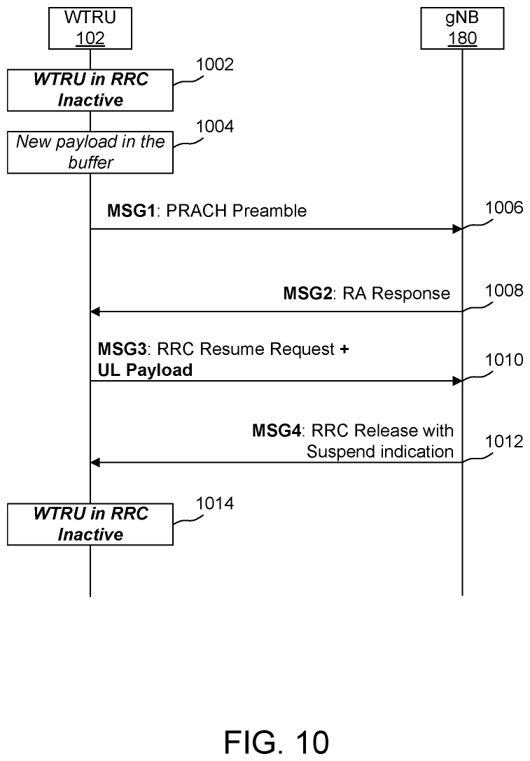

FIG. 10 is a timing diagram illustrating an example of a 4-step RA procedure with SDT. In FIG. 10, the WTRU 102 may be in RRC Inactive at 1002. At 1004, a new UL payload may be provided in a buffer of the WTRU 102 (e.g., waiting for transmission). At 1006, the WTRU 102 may send a Msg1 (e.g., PRACH preamble) to the gNB 180. The WTRU 102 may receive a Msg2 (e.g., RA response) from the gNB 180 at 1008. The WTRU 102 may send a Msg 3 (e.g., a RRC resume request) at 1010. For example, the Msg3 may carry (e.g., include) an UL payload as the SDT information. The WTRU 102 may receive a Msg4 from the gNB 180 at 1012. For example, the Msg4 may be a RRC release with a suspend indication from the gNB to keep the WTRU 102 in RRC_INACTIVE at 1014.

In certain representative embodiments, a 2-step RA procedure may include SDT.

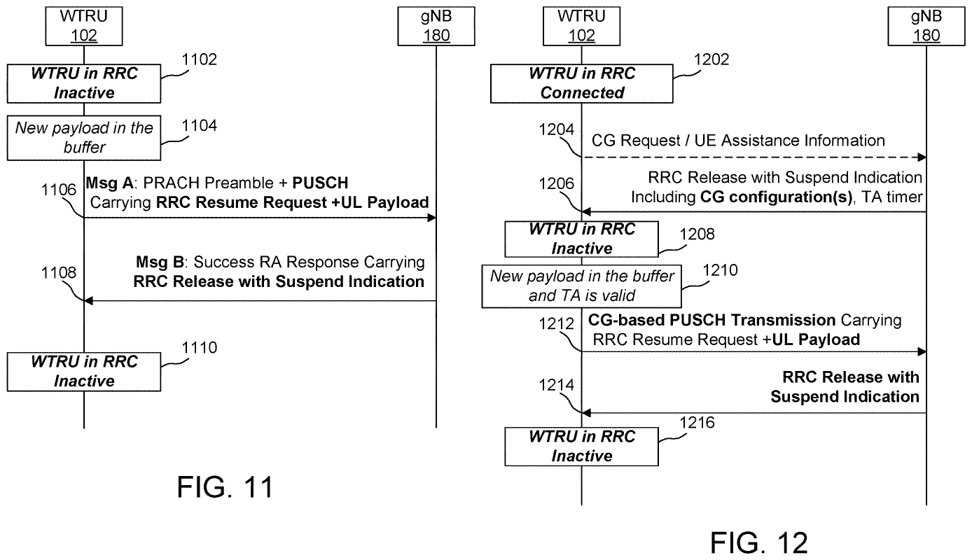

FIG. 11 is a timing diagram illustrating an example of a 2-step RA procedure with SDT. In FIG. 11, the WTRU 102 may be in RRC Inactive at 1102. At 1104, a new UL payload may be provided in a buffer of the WTRU 102 (e.g., waiting for transmission). At 1106, the WTRU 102 may send a MsgA to the gNB. For example, the MsgA may include a PRACH preamble and a PUSCH transmission carrying (e.g., including) a RRC resume request and/or a UL payload (e.g., which was buffered at 1104) as the SDT information. The WTRU 102 may receive a MsgB from the gNB 180 at 1108. For example, the MsgB may be a RRC release with a suspend indication from the gNB 180 to keep the WTRU 102 in RRC_INACTIVE.

For example, the UL payload transmission happens with MsgA of the 2-step RA procedure. The UL payload transmission may use PUSCH resources that are pre-configured by the gNB 180 and broadcasted in system information, such as the associated physical transmission parameters (e.g., number and/or location of physical resource blocks (PRBs), modulation and coding scheme (MCS)). The reception of a successful random access response (RAR) message at 1108 including an RRC release with suspend indication may indicate the WTRU 102 to remain in RRC_INACTIVE.

For example, the RA 2-step based SDT may enable to reduce the packet delay and associated signaling overhead (e.g., as compared to 4-step RA SDT). However, the 2-step RA delay may increase if a collision happens when multiple WTRUs 102 compete for the same shared PUSCH resources when respectively transmitting MsgA.

### Configured Grant (CG) Transmissions

FIG. 12 is a timing diagram illustrating an example of a configured grant (CG) procedure with SDT.

In certain representative embodiments, a WTRU 102 may perform CG-based SDT. For example, a UL payload may be transmitted on pre-configured PUSCH resources, such as on condition the WTRU 102 has a valid timing alignment (TA). For example, the SDT may be a CG-type1 transmission.

In FIG. 12, the WTRU 102 may be in RRC Connected at 1202. At 1204, the WTRU 102 may send a CG request and/or UE assistance information to the gNB 180. At 1206, the WTRU 102 may receive a RRCRelease message with a suspend indication. For example, the message may include one or more CG configurations and/or a TA timer (e.g., timer value). At 1208, the WTRU is in RRC Inactive. At 1210, a new UL payload may be provided in a buffer of the WTRU 102 (e.g., waiting for transmission) and the WTRU 102 may determine that the TA with the gNB 180 is valid. At 1212, the WTRU 102 may send a CG-based PUSCH transmission which carries a RRCResumeRequest message and an UL payload (e.g., which was buffered at 1210). At 1214, the WTRU 102 may receive from the gNB 180 a RRCRelease message with a suspend indication. At 1216, the WTRU 102 may remain in RRC Inactive (e.g., without transitioning to RRC Connected).

In certain representative embodiments, the WTRU 102 may request for one or more CG configuration(s) (e.g., based on data traffic pattern) while in RRC connected state. For example, the CG configurations may be received as part of the RRC release with suspend indication. A CG configuration may be WTRU-specific. A received CG configuration may include, among other information, a PUSCH resource allocation and periodicity.

As can be seen from FIG. 3, it may be desirable for the WTRUs to inform the network (e.g., FL training entity) about availability for training. Based on the informed availability and the needs of the training, the network may select a subset of the devices to perform training and send the training result (e.g., updated metadata) when it is ready (e.g., when the training converges according to convergence criteria).

For example, a requirement for the WTRUs to be in the CONNECTED state for all the phases of FIG. 3 (e.g., training resource availability reporting, reception of model updates, training, sending the training result, etc.) may be (e.g., highly) inefficient for WTRU 102 power consumption, unless the WTRU 102 also has active UL/DL user plane data at the same time.

In certain representative embodiments, a WTRU 102 may perform one or more procedures such that the WTRU 102 is connected to a PLMN via an access point (e.g., gNB), and thus has performed a registration process.

In certain representative embodiments, a WTRU 102 may support the RRC_INACTIVE state. The network may check the same using UE Capability Information.

In certain representative embodiments, the RAN (e.g., 5G RAN) may support data and analytics exposure to an AS/AF via a core network (e.g., 5GC). For example, an AS/AF may subscribe or request data and/or analytics from a core network and RAN.

In certain representative embodiments, a core network may employ a dedicated network function for handling AIML workflows such as FL.

In certain representative embodiments, a WTRU 102 may operate in a low power state. As used herein, a low power state, a low power operating mode, and/or a lower power state may refer to any state other than the RRC_CONNECTED state (e.g., a higher power operating mode). For example, a low(er) power state may refer to the RRC_INACTIVE. In another example, a low(er) power state may refer to RRC_IDLE. In another example, it may refer to a state in between the RRC_CONNECTED state and the RRC_INACTIVE state where the level of DCI monitoring of the WTRU 102 is between the (e.g., typical) levels for RRC_CONNECTED state and RRC_INACTIVE states.

### Configurations to Report Resource Availability for Federated Learning

In certain representative embodiments, a WTRU 102 may receive information indicating one or more configurations including information associated with reporting resource availability for federated learning.

In certain representative embodiments, a WTRU 102 may be configured by the network to report its resource availability for federated learning.

In certain representative embodiments, a WTRU 102 may be configured by the network to stop reporting its resource availability for federated learning.

In certain representative embodiments, a WTRU 102 may be configured to send information indicating resource availability in a periodic manner (e.g., every X seconds).

In certain representative embodiments, a WTRU 102 may be configured with a start and/or a stop time(s) (e.g., absolute times, relative times from the reception of the configuration, etc.) for providing the resource availability. For example, a WTRU 102 may be configured with a periodic reporting of X seconds, and a stop time of t_stop. The WTRU 102 may send resource availability information to the network every X seconds until the specified stop time has elapsed.

In certain representative embodiments, a WTRU 102 may be configured with a number of (e.g., requested) resource availability reports to be sent to the network. For example, a WTRU 102 may be configured with a periodic reporting of X seconds, and a number of reports of N. The WTRU 102 may send N resource availability reports to the network, each X seconds apart. In another example, a WTRU 102 may be configured with N=1, and a t_start. The WTRU 102 may send a resource availability report (e.g., only) once at the specified t_start.

In certain representative embodiments, a WTRU 102 may be configured to report resource availability associated with a AI/ML RAN function. For example, reported resource availability may be configured to be associated with a name of the functionality (e.g., Radio Resource Management, Beam Management, Positioning, etc.). For example, reported resource availability may be configured to be associated with identification (e.g., an ID) of a model for a AI/ML RAN function.

In certain representative embodiments, a WTRU 102 may be configured to report resource availability for multiple AI/ML RAN functions and/or AI/ML models at once. For example, a WTRU 102 may provide a report with information indicating different resource availabilities which are associated with different AI/ML functions and/or models at a respectively configured reporting time.

In certain representative embodiments, a WTRU 102 may be configured to report resource availability for any (e.g., all) AI/ML RAN functions and/or models (e.g., supported by the WTRU 102).

In certain representative embodiments, a WTRU 102 may receive configuration information for resource availability reporting via (e.g., dedicated) signaling while in CONNECTED mode (e.g., RRC reconfiguration message, NAS message, etc.).

In certain representative embodiments, a WTRU 102 may receive configuration information for resource availability reporting while transitioning to a lower power state. For example, a WTRU 102 may receive the configuration information during the transition to any of INACTIVE or IDLE state (e.g., via RRC release message).

In certain representative embodiments, a WTRU 102 may receive configuration information for resource availability reporting while transitioning to a CONNECTED state (e.g., RRC Resume message, RRC Setup message).

In certain representative embodiments, a WTRU 102 may receive configuration information for resource availability reporting via broadcast signaling. For example, the configuration information may be received using one or more of any of a (e.g., new) information element, in system information (e.g., SIB1, SIB2, etc.), and/or in a (e.g., new) SIBx for AI/ML related configuration.

In certain representative embodiments, a WTRU 102 may have already received a resource availability reporting configuration while in CONNECTED state. For example, the WTRU may maintain the reporting configuration upon transitioning to a lower power state (e.g., INACTIVE or IDLE state).

In certain representative embodiments, a WTRU 102 may, upon determining that a (e.g., new or updated) resource availability reporting configuration is available via broadcast signaling, release any (e.g., prior) resource availability reporting configuration that it may have received earlier, such as via dedicated signaling and may apply the broadcasted configuration.

In certain representative embodiments, a WTRU 102 may, upon determining that a (e.g., previous) resource availability reporting configuration was received via dedicated signaling (e.g., RRC reconfiguration, RRC release, RRC resume, RRC setup, etc.), ignore (e.g., discard) a resource availability reporting configuration that is available via broadcast signaling.

In certain representative embodiments, a WTRU 102 may receive configuration information for resource availability reporting via a paging message (e.g., RAN paging or CN paging). For example, the paging message may be an individual WTRU paging or a group paging message. For example, a group paging identity may be assigned for resource availability reporting (e.g., for any reporting, for a reporting regarding a particular AI/ML function, for a reporting regarding a particular AI/ML model, etc.,). Any (e.g., each) WTRU 102, upon detecting a paging indication associated with the paging identity, start the resource availability reporting (e.g., on condition the WTRU 102 is assigned the paging identity).

In certain representative embodiments, a WTRU 102 may be configured with a reporting configuration according to any of the embodiments above. The WTRU 102 may wait to receive information indicating (e.g., a configuration and/or signal from the network) to activate the reporting configuration. For example, a reporting configuration may be activated using any of (e.g., an indication in) a dedicated RRC message (e.g., RRC reconfiguration, RRC Release, RRC Resume, RRC setup), a broadcast RRC message (e.g., SIB signaling), a MAC CE, a DCI, and/or a paging message.

In certain representative embodiments, a WTRU 102 may be configured to stop and/or deactivate a previously configured reporting configuration according to any of the solutions above. For example, a reporting configuration may be deactivated using any of (e.g., an indication in) a dedicated RRC message (e.g., RRC reconfiguration, RRC Release, RRC Resume, RRC setup), a broadcast RRC message (e.g., SIB signaling), a MAC CE, a DCI, and/or a paging message.

In one solution, if the WTRU 102 has received the reporting configuration regarding several AI/ML functions or/and models, the activation or deactivation signals may include an identification of the concerned function(s) or/and model(s) (or an indication that the activation/deactivation is concerning all the functions or/and models).

### Resource Availability Reports

In certain representative embodiments, a WTRU 102 may send a resource availability report which includes an (e.g., binary) indication whether (e.g., sufficient) resources are available at the WTRU 102 or not (e.g., whether the WTRU 102 can perform the training or not).

In certain representative embodiments, a resource availability report may include timing information (e.g., when a WTRU 102 can start the training, for how long the WTRU 102 can perform the training, etc.).

In certain representative embodiments, a resource availability report may include a cost of the training for the respective WTRU 102 (e.g., how much battery power, such as in percentage terms, training will use, how long the training is expected to take, etc.).

In certain representative embodiments, a WTRU 102 may be configured with a reporting configuration for several AI/ML functions/models. The WTRU 102 may send a resource availability report that includes a bitmap. For example, each bit of the bitmap may indicate the availability or unavailability of resources for a given function and/or model. As an example, a WTRU 102 may be configured for reporting the resource availability related to 8 AI/ML models. The WTRU 102 may send a one octet bitmap, where each bit is associated with a particular one of the 8 AI/ML models. For example, a 0 may indicate resource unavailability, and 1 may indicate resource availability, or vice versa. The order of the bits may be, for example, in accordance with the model ID, for example, in ascending or descending order, or according to some preconfigured association of the bitmaps and the different models.

In certain representative embodiments, a WTRU 102 may be configured with reporting configurations for several AI/ML functions and/or models, and a resource availability report may be a plurality of bitmaps. For example, any (e.g., each) bitmap may indicate a resource availability for performing the training of a respective combination of the different functions and/or models. For example, a WTRU 102 may be configured to report resource availability for AI/ML models 0 to 7, and the WTRU 102 may send the following bitmaps:
(i) 11100000;
(ii) 10110000;
(iii) 00111000; and
(iv) 00010010.

For example, the first bitmap (i) may indicate that the WTRU 102 can perform the training of models 7,6 and 5 together. The second bitmap (ii) may indicate training for models 7,5 and 4 together. The third bitmap may indicate training for models 5,4,3 together. The fourth bitmap may indicate training for models or models 4 and 1 together.

In certain representative embodiments, a WTRU 102 may include (e.g., additional) timing and/or cost related information, such as with the above bitmap-based examples.

### Resource Availability Reporting

In certain representative embodiments, a WTRU 102 in the CONNECTED state may send a resource availability report to the network in a NAS message.

In certain representative embodiments, a WTRU 102 in the CONNECTED state may send a resource availability report to the network in an RRC message. For example, a resource availability report may be sent using an existing message, such as a UE Assistance Information message or a measurement report. For example, a new RRC message may be defined to send the resource availability report.

In certain representative embodiments, a WTRU 102 in CONNECTED state may send a resource availability report to the network in a MAC CE.

In certain representative embodiments, a WTRU 102 in CONNECTED state may send a resource availability report to the network using an uplink control information (UCI). For example, the UCI may be a scheduling request (SR) that implicitly indicates the resource availability or unavailability.

In certain representative embodiments, a WTRU 102 that is in a low power state (e.g., IDLE or INACTIVE state) may send a resource availability report (e.g., indication) using a pre-configured RACH preamble, such as during a 2-step and/or 4-step RACH procedure. For example, a WTRU 102 may be configured with a RACH preamble to indicate that resources are available for a respective AI/ML model and/or function training, and another RACH preamble to indicate that resources are not available for the respective AI/ML model and/or function training. For example, a WTRU 12 may be configured with a set of different RACH preambles, each indicating resource availability for the respective training of one or more RAN functions.

In certain representative embodiments, a WTRU 102 that is in a low power state (e.g., IDLE or INACTIVE state) may trigger an RRC connection resume and/or connection setup to send the resource availability report (e.g., indication). For example, a WTRU 102 may send an RRCResumeRequest, or RRCSetupRequest, message with a (e.g., new) cause value (E.g., ai_ml_report_available).

In certain representative embodiments, a WTRU 102 may be configured to use different WTRU identities (e.g., resume identities, initial WTRU identities, etc.) in the connection resume and/or connection setup messages. For example, each identity may be associated with an indication of availability, or unavailability, of resources for performing training for a respective AI/ML function/model, or set of AI/ML functions or models.

In certain representative embodiments, a WTRU 102 may receive an RRCResume or RRCSetup message in response to the RRCResumeRequest or RRCSetupRequest. The WTRU 102 may transitions to a CONNECTED state, and can use any of the examples described herein for the CONNECTED UE (e.g., NAS, RRC, MAC CE, UCI, etc.), to send the resource availability report.

In certain representative embodiments, a WTRU 102 may use a SDT to send a resource availability report (e.g., without transitioning to the CONNECTED state). For example, a resource availability report may be sent with Msg 3 during a 4-step RACH SDT. For example, a resource availability report may be sent with Msg A during a 2-step RACH SDT. For example, a resource availability report may be transmitted along with a resume request via a configured grant.

In certain representative embodiments, a WTRU 102 may receive a RRCRelease message in response to the RRCResumeRequest and/or RRCSetupRequest that it has sent (e.g., if the resource availability report was indicated implicitly/explicitly in the resume/setup request, if the resource availability report was explicitly indicate with SDT, etc.).

In certain representative embodiments, a WTRU 102 may have indicated a first (e.g., implicit or short) resource availability report, and the network may decide to transition the WTRU 102 to CONNECTED state. After transitioning to the CONNECTED state, the WTRU 102 may send a second (e.g., explicit or long) resource availability report. For example, the network may include an indication of the required detailed report in the RRC Resume or RRC Setup message. As another example, the network may send the WTRU 102 an RRC Reconfiguration message (e.g., UE Assistance Information) with such an indication.

In certain representative embodiments, a WTRU 102 may receive information (e.g., an indication) as to whether the WTRU 102 can perform the resource availability reporting in a low power state (e.g., IDLE and/or INACTIVE) or that the WTRU 102 has to transition to the CONNECTED state. For example, this information may be received in a resource availability reporting configuration, such as according to any of the examples described herein. In another example, this information may be received in the activation of the resource availability reporting, such as according to any of the examples described herein.

In certain representative embodiments, a WTRU 102 may be configured with one or more buffer level thresholds that determine a procedure to be used for sending the resource availability report. For example, a WTRU 102 may be configured to use a SDT based reporting (e.g., only) on condition a size of the resource availability report is below a threshold. For example, may be configured to transition to a CONNECTED state and send the resource availability report in the CONNECTED state (e.g., using an RRC message such as the UE assistance information) (e.g., only) on condition the size of the report is above a threshold.

### One-Shot and Immediate Reporting

In certain representative embodiments, it may be assumed that a WTRU 102 sends a resource availability report using a previously received configuration, such as periodically, or when certain conditions are fulfilled (e.g., enough resource become available, etc.,).

In certain representative embodiments, a WTRU 102 in the CONNECTED state may receive an explicit (e.g., one-shot) request from the network to send an AI/ML resource availability report (e.g., a NAS message, an existing RRC message, such as a UE information Request, a new RRC message defined for requesting reporting, a MAC CE, a DCI, etc.). For example, a request may include detailed information such as the concerned AI/ML RAN function(s) or model(s).

In certain representative embodiments, a WTRU 102 in a low power state (e.g., IDLE or INACTIVE state) may receive paging information (e.g., a CN paging indication for where the WTRU 102 is in IDLE, or RAN paging indication for where the WTRU 102 is in INACTIVE) from the network to send an AI/ML resource availability report. For example, the paging information may be associated with a particular WTRU identity or a group identity that the WTRU is associated (e.g., pre-configured) with. For example, the paging information may include an implicit (e.g., based on the paging identity) or explicit (e.g., additional information in the paging message) information regarding the concerned AI/ML function(s) or model(s) the WTRU should report about. For example, a WTRU 102 may respond to the paging (e.g., with an RRC Resume Request or RRC Setup Request message), such as (e.g., only) where the WTRU 102 has resources available (e.g., for the indicated AI/ML functions/models).

In certain representative embodiments, a WTRU 102 in any of the IDLE, INACTIVE, and/or CONNECTED states may receive a broadcast signal (e.g., any of the system information blocks) that indicates for the WTRU 102 to send a one-shot AI/ML resource availability report (e.g., indication). The broadcasted signal may include information regarding the concerned AI/ML function(s) or model(s) the WTRU 102 should report about. For example, a WTRU 102 may respond to the indication (e.g., only) on condition that resources are available (e.g., for the indicated AI/ML functions/models). A WTRU 102 may send a resource availability report using any of the procedures described herein (e.g., any of SDT, 2-step resume, RACH preambles, reporting via an RRC message while in CONNECTED state or after transitioning to a CONNECTED state, etc.,) could be used to send the one-shot report.

In certain representative embodiments, a WTRU 102 may receive additional information (e.g., an indication) in the one-shot request as to whether to perform the resource availability reporting in the RRC_CONNECTED state or a in a low power state (e.g., IDLE and/or INACTIVE).

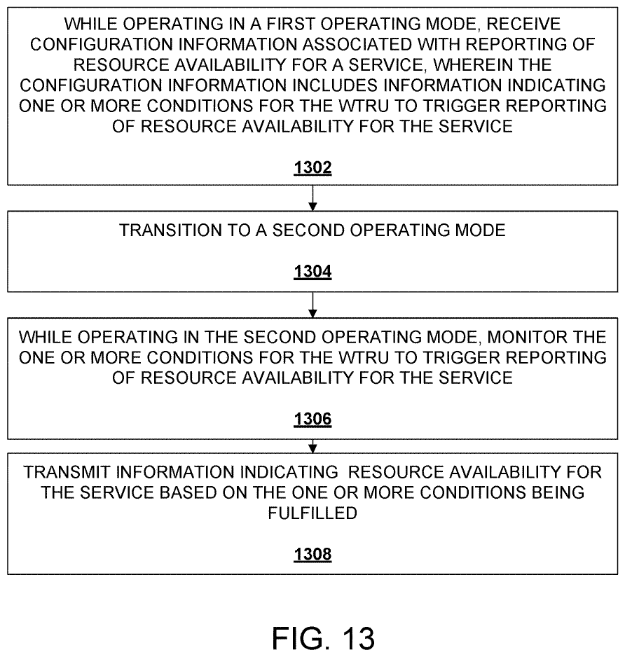

FIG. 13 is a procedural diagram illustrating an example procedure for reporting of resource availability for a service. A WTRU 102 may be configured to perform (e.g., implement as a method) the procedure shown in FIG. 13. At 1302, the WTRU 102, while operating in a first operating mode, may receive configuration information associated with reporting of resource availability (e.g., at the WTRU 102) for a service. For example, the configuration information may include information indicating one or more conditions (e.g., available resources required for the service at the WTRU 102) for the WTRU to trigger reporting of resource availability. For example, the configuration information may include information indicating (e.g., one or more types of) the content to be provided by the WTRU when reporting resource availability. At 1304, the WTRU 102 may transition to a second operating mode. At 1306, the WTRU 102, while operating in the second operating mode, may monitor the one or more conditions for the WTRU 102 to trigger resource availability reporting. At 1308, the WTRU 102 may transmit (e.g., report) information indicating resource availability for the service based on the one or more conditions being fulfilled.

For example, the service may be associated with federated learning using one or more AI/ML models and/or functions. As an example, the AI and/or ML models and/or functions (e.g., at the WTRU 102) may be associated with the service.

For example, the resource availability for the service may indicate federated learning resource availability at the WTRU 102.

For example, a resource availability indication may be transmitted at 1308 using any of the techniques described herein. As an example, the information indicating the resource availability for the service (e.g., indication) may include the use of (e.g., preconfigured) RACH resources. As an example, the information indicating the resource availability (e.g., indication) may include the use of a (e.g., configured) resume identity, such as I-RNTI. As an example, a Msg3 UL payload, such as at 1010, may include the information indicating the resource availability (e.g., indication). As an example, a MsgA UL payload, such as at 1106, may include the information indicating the resource availability (e.g., indication). As an example, a CG-based transmission may include the information indicating the resource availability (e.g., indication as part of the UL payload at 1212).

In certain representative embodiments, the WTRU 102 may (e.g., further) receive the configuration information that includes information indicating a set of resources required (e.g., to be available) for the service at the WTRU 102. For example, the set of resources may include any of (i) a required battery power level of the WTRU 102, (ii) a required amount of memory of the WTRU 102, (iii) a required processor capacity of the WTRU 102, and/or (iv) one or more AI and/or ML models and/or functions required at the WTRU 102.

In certain representative embodiments, the one or more conditions may include any of (i) a set of resources required for the service at the WTRU 102, (ii) a periodicity of resource availability reporting (e.g., a reporting timing), (iii) one or more AI and/or ML models and/or functions required to be available at the WTRU 102, and/or (iv) reception of an explicit request to send resource availability for the service.

In certain representative embodiments, the first operating mode may be a full power operating mode.

In certain representative embodiments, the second operating mode may be a reduced power operating mode.

In certain representative embodiments, the WTRU 102 may (e.g., further) receive a RRC message associated with the transition to the second operating mode.

In certain representative embodiments, the information indicating resource availability, such as at 1308, may include (e.g., be transmitted as) any of a random access channel preamble, a WTRU identifier, or an explicit indication.

In certain representative embodiments, the information indicating resource availability may be transmitted, such as at 1308, using any of non-access stratum (NAS) signaling, radio resource control (RRC) signaling, a medium access control (MAC) control element (CE), or uplink control information (UCI).

In certain representative embodiments, the information indicating resource availability may be transmitted, such as at 1308, while operating in the second operating mode.

In certain representative embodiments, the WTRU 102 may (e.g., further) transitioning to the first operating mode; and while operating in the first operating mode, transmitting (e.g., after 1308) additional information indicating resource availability. For example, at 1308, the WTRU 102 may indicate (e.g., to the network) that the required set of resources are available at the WTRU 102. The additional information may indicate (e.g., to a further extent) what resources (e.g., battery power level, free memory, and/or processing capacity) are available at the WTRU 102 beyond the required set of resources. As an example, a battery level of at least X1% and/or a free amount of memory of Y1 Mbytes may be required at the WTRU 102, and the additional information may indicate that a battery level of X2% and/or a free amount of memory of Y2 Mbytes are available at the WTRU 102 (e.g., where X2>X1 and Y2>Y1). This may be beneficial in allowing the network to (e.g., only) select certain WTRUs which have comparatively more available resources beyond the required set of resources.

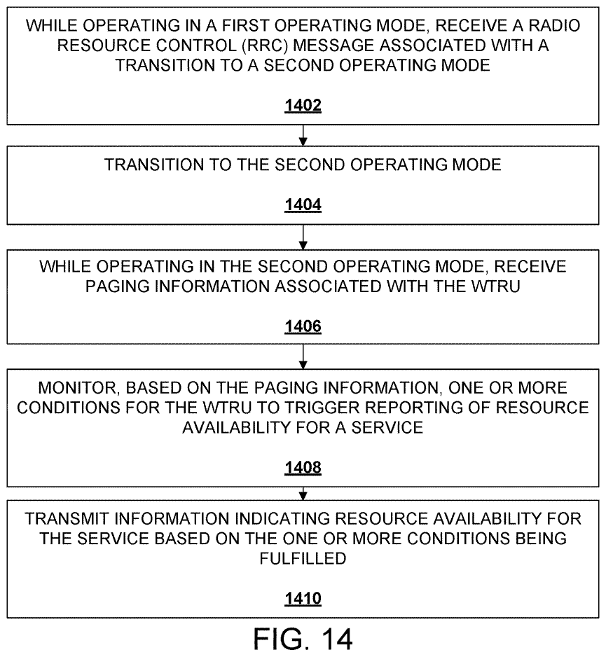

FIG. 14 is a procedural diagram illustrating an example procedure for reporting of resource availability for a service using paging information. A WTRU 102 may be configured to perform (e.g., implement as a method) the procedure shown in FIG. 14. At 1402, while operating in a first operating mode, the WTRU 102 may receive a RRC message associated with a transition to a second operating mode. At 1404, the WTRU 102 may transition to the second operating mode. At 1406, while operating in the second operating mode, the WTRU 102 may receive paging information associated with the WTRU 102. The WTRU 102 may monitor, based on the paging information, one or more conditions for the WTRU 102 to trigger reporting of resource availability for a service at 1408. At 1410, the WTRU 102 may transmit (e.g., report) information indicating resource availability for the service based on the one or more conditions being fulfilled.

For example, the service may be associated with federated learning using one or more AI/ML models and/or functions. As an example, the AI and/or ML models and/or functions(e.g., at the WTRU 102) may be associated with the service.

For example, the resource availability for the service may indicate federated learning resource availability at the WTRU 102.

For example, a resource availability indication may be transmitted at 1410 using any of the techniques described herein. As an example, the information indicating the resource availability (e.g., indication) may include the use of (e.g., preconfigured) RACH resources. As an example, the information indicating the resource availability (e.g., indication) may include the use of a (e.g., configured) resume identity, such as I-RNTI. As an example, a Msg3 UL payload, such as at 1010, may include the information indicating the resource availability (e.g., indication). As an example, a MsgA UL payload, such as at 1106, may include the information indicating the resource availability (e.g., indication). As an example, a CG-based transmission may include the information indicating the federated learning resource availability (e.g., indication as part of the UL payload at 1212).

In certain representative embodiments, the WTRU 102 may (e.g., further), while operating in the first operating mode, receive configuration information associated with reporting of resource availability for the service. For example, the configuration information may include information indicating the one or more conditions for the WTRU 102 to trigger the reporting of resource availability.

In certain representative embodiments, the WTRU 102 may (e.g., further) receive a signal indicating to activate the configuration information. For example, the signal may include any of the paging information, a RRC message, a MAC CE, and/or DCI.

In certain representative embodiments, the paging information may be associated with reporting of resource availability. For example, the paging information may include information indicating the one or more conditions for the WTRU 102 to trigger reporting of resource availability.

In certain representative embodiments, the WTRU 102 may (e.g., further) receive configuration information indicating a set of resources required (e.g., to be available) for the service at the WTRU 102. For example, the set of resources may include any of (i) a required battery power level of the WTRU 102, (ii) a required amount of memory of the WTRU 102, (iii) a required processor capacity of the WTRU 102, and/or (iv) one or more AI and/or ML models and/or functions required at the WTRU 102.

In certain representative embodiments, the one or more conditions include any of (i) a set of resources required for the service at the WTRU 102, (ii) a periodicity of resource availability reporting, (iii) one or more AI and/or ML models and/or functions required to be available at the WTRU 102; and/or (iv) reception of an explicit request to send resource availability for the service.

In certain representative embodiments, the first operating mode may be a full power operating mode.

In certain representative embodiments, the second operating mode may be a reduced power operating mode.

In certain representative embodiments, the information indicating resource availability, such as at 1410, may include any of a random access channel preamble, a WTRU identifier, or an explicit indication.

In certain representative embodiments, the information indicating resource availability may be transmitted, such as at 1410, using any of NAS signaling, RRC signaling, a MAC CE, and/or UCI.

In certain representative embodiments, the information indicating resource availability may be transmitted (e.g., at 1410) while operating in the second operating mode.

In certain representative embodiments, the WTRU 102 may (e.g., further) transition to the first operating mode (e.g., after 1410). While operating in the first operating mode, the WTRU 102 may transmit additional information indicating resource availability. For example, at 1410, the WTRU 102 may indicate (e.g., to the network) that the required set of resources are available at the WTRU 102. The additional information may indicate (e.g., to a further extent) what resources (e.g., battery power level, free memory, and/or processing capacity) are available at the WTRU 102 beyond the required set of resources. As an example, a processing capacity of at least X1% and/or a free amount of memory of Y1 Mbytes may be required at the WTRU 102, and the additional information may indicate that a processing capacity of X2% and/or a free amount of memory of Y2 Mbytes are available at the WTRU 102 (e.g., where X2>X1 and Y2>Y1). This may be beneficial in allowing the network to (e.g., only) select certain WTRUs which have comparatively more available resources beyond the required set of resources.

In certain representative embodiments, the paging information, such as at 1406, may indicate a group associated with the WTRU.

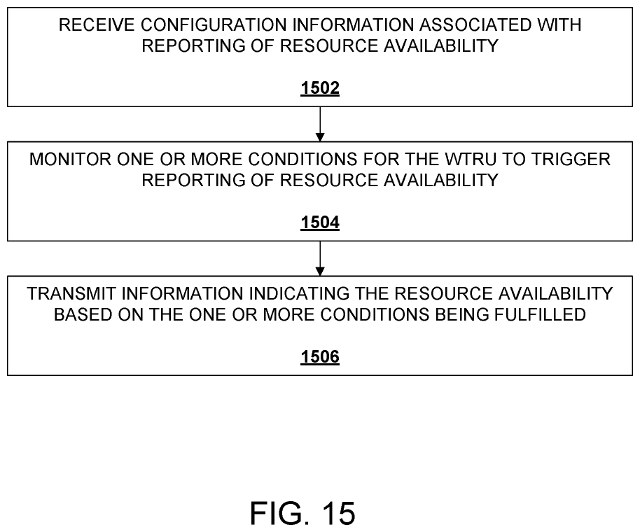

FIG. 15 is a procedural diagram illustrating another example procedure for reporting of resource availability (e.g., for a service). A WTRU 102 may be configured to perform (e.g., implement as a method) the procedure shown in FIG. 15. At 1502, the WTRU 102 may receive configuration information associated with reporting of resource availability. For example, the configuration information may include information indicating one or more conditions for the WTRU 102 to trigger reporting of resource availability. At 1504, the WTRU 102 may monitor the one or more conditions for the WTRU 102 to trigger reporting of resource availability. At 1506, the WTRU 102 may transmit (e.g., report) information indicating the resource availability based on the one or more conditions being fulfilled.

For example, the service may be associated with federated learning using one or more AI/ML models and/or functions. As an example, the AI and/or ML models and/or functions (e.g., at the WTRU 102) may be associated with the service.

For example, the resource availability for the service may indicate federated learning resource availability at the WTRU 102

For example, a resource availability indication may be transmitted at 1506 using any of the techniques described herein. As an example, the information indicating the resource availability (e.g., indication) may include the use of (e.g., preconfigured) RACH resources. As an example, the information indicating the resource availability (e.g., indication) may include the use of a (e.g., configured) resume identity, such as I-RNTI. As an example, a Msg3 UL payload, such as at 1010, may include the information indicating the resource availability (e.g., indication). As an example, a MsgA UL payload, such as at 1106, may include the information indicating the resource availability (e.g., indication). As an example, a CG-based transmission may include the information indicating the resource availability (e.g., indication as part of the UL payload at 1212).

In certain representative embodiments, a WTRU 102 may be configured to perform a procedure (e.g., implement as a method) which includes to receive (e.g., from a network entity) first information indicating a resource availability reporting configuration associated with training one or more AI and/or ML functions and/or models. The WTRU 102 may send (e.g., to the network entity), based on (e.g., in accordance with) the received first information, second information indicating one or more resources are available (e.g., at the WTRU) for training the one or more AI and/or ML functions and/or models.

For example, the first information may be received in any of broadcast signaling, dedicated signaling, a RRC message (e.g., associated with a transition from a first state to a second state), a MAC CE, DCI, and/or paging information.

In certain representative embodiments, the WTRU 102 may send a (SDT) which includes the second information.

In certain representative embodiments, the WTRU 102 may perform a two-step RACH procedure which includes sending a first message that includes an UL payload. The UL payload may include the second information.

For example, the two-step RACH procedure may include receiving a second message that includes information indicating an I-RNTI for the WTRU 102.

In certain representative embodiments, the WTRU 102 may perform a four-step RACH procedure which includes sending a first message, receiving a second message, and sending a third message that includes an UL payload. The UL payload may include the second information.

For example, the four-step RACH procedure may include receiving a fourth message that includes information indicating an I-RNTI for the WTRU 102.

In certain representative embodiments, the WTRU 102 may receive information indicating a CG configuration and an I-RNTI for the WTRU 102. The WTRU 102 may send an UL payload using the CG configuration. The UL payload may include the second information.

For example, after sending the UL payload using the CG configuration, the WTRU 102 may receive information indicating an I-RNTI for the WTRU 102.

In certain representative embodiments, the second information may be, or include, a RACH preamble.

In certain representative embodiments, the second information may be, or include, one or more bitmaps indicating respective combinations of the AI and/or ML models and/or functions for which the one or more resources are available for training.

In certain representative embodiments, the WTRU 102 may receive information indicating the one or more AI/ML models and/or functions. After reporting the second information, the WTRU 102 may perform training of the one or more AI/ML models and/or functions. The WTRU 102 may send information associated with a result of the training of the one or more AI/ML models and/or functions.

In certain representative embodiments, the WTRU 102 may send (e.g., to the network entity), based on (e.g., in accordance with) the received first information, third information indicating the one or more resources are available for training the one or more AI and/or ML functions and/or models. The third information may be associated with a higher level of reporting (e.g., more detailed) than the second information.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method implemented by a wireless transmit/receive unit (WTRU), the method comprising:
while operating in a first operating mode, receiving configuration information associated with reporting of resource availability for a service, wherein the configuration information includes information indicating one or more conditions for the WTRU to trigger reporting of resource availability for the service;
transitioning to a second operating mode;
while operating in the second operating mode, monitoring the one or more conditions for the WTRU to trigger reporting of resource availability for the service; and
transmitting information indicating resource availability for the service based on the one or more conditions being fulfilled.

2. The method of claim 1, wherein the service is associated with using one or more artificial intelligence (AI) and/or machine learning (ML) models and/or functions.

3. The method of claim 1,
wherein the configuration information includes information indicating a set of resources required for the service at the WTRU, and wherein the set of resources includes any of a required battery power level of the WTRU, a required amount of memory of the WTRU, a required processor capacity, and/or one or more artificial intelligence (AI) and/or machine learning (ML) models and/or functions required at the WTRU.

4. The method of claim 1, wherein the one or more conditions include any of (i) the availability of a set of resources required for the service at the WTRU, (ii) a periodicity of resource availability reporting, (iii) one or more artificial intelligence (AI) and/or machine learning (ML) models and/or functions required to be available at the WTRU for using the service, and/or (iv) reception of an explicit request to send resource availability for the service.

5. The method of claim 1, wherein the first operating mode is a full power operating mode.

6. The method of claim 1, wherein the second operating mode is a reduced power operating mode.

7. The method of claim 1, further comprising:
receiving a radio resource control (RRC) message associated with the transition to the second operating mode.

8. The method of claim 1, wherein the information indicating resource availability for the service includes any of a random access channel preamble, a WTRU identifier, or an explicit indication.

9. The method of claim 1, wherein the information indicating resource availability for the service is transmitted using any of non-access stratum (NAS) signaling, radio resource control (RRC) signaling, a medium access control (MAC) control element (CE), or uplink control information (UCI).

10. The method of claim 1, wherein the information indicating resource availability for the service is transmitted while operating in the second operating mode.

11. (canceled)

12. A wireless transmit/receive unit (WTRU) comprising:
a processor, a memory, and a transceiver which are configured to:
while operating in a first operating mode, receive configuration information associated with reporting of resource availability for a service, wherein the configuration information includes information indicating one or more conditions for the WTRU to trigger reporting of resource availability for the service,
transition to a second operating mode,
while operating in the second operating mode, monitor the one or more conditions for the WTRU to trigger reporting of resource availability for the service, and
transmit information indicating resource availability for the service based on the one or more conditions being fulfilled.

13. The WTRU of claim 12, wherein the service is associated with using one or more artificial intelligence (AI) and/or machine learning (ML) models and/or functions.

14. The WTRU of claim 12,
wherein the configuration information includes information indicating a set of resources required for the service at the WTRU, and
wherein the set of resources includes any of a required battery power level of the WTRU, a required amount of memory of the WTRU, a required processor capacity of the WTRU, and/or one or more artificial intelligence (AI) and/or machine learning (ML) models and/or functions required at the WTRU.

15. The WTRU of claim 12, wherein the one or more conditions include any of (i) the availability of a set of resources required for the service at the WTRU, (ii) a periodicity of resource availability reporting, (iii) one or more artificial intelligence (AI) and/or machine learning (ML) models and/or functions required to be available at the WTRU for using the service, and/or (iv) reception of an explicit request to send resource availability for the service.

16. The WTRU of claim 12, wherein the first operating mode is a full power operating mode.

17. The WTRU of claim 12, wherein the second operating mode is a reduced power operating mode.

18. The WTRU of claim 12, wherein the processor, the memory, and the transceiver are further configured to:
receive a radio resource control (RRC) message associated with the transition to the second operating mode.

19. The WTRU of claim 12, wherein the information indicating resource availability for the service includes any of a random access channel preamble, a WTRU identifier, or an explicit indication.

20. The WTRU of claim 12, wherein the information indicating resource availability for the service is transmitted using any of non-access stratum (NAS) signaling, radio resource control (RRC) signaling, a medium access control (MAC) control element (CE), or uplink control information (UCI).

21. The WTRU of claim 12, wherein the information indicating resource availability for the service is transmitted while operating in the second operating mode.

22. (canceled)
